(19) United States
(12) Patent Application Publication
(10) Pub. No.: US 2025/0349169 A1
(43) Pub. Date: Nov. 13, 2025

(54) CASH PROCESSING MACHINE AND ALARM OUTPUT METHOD

(71) Applicants: FUJITSU FRONTECH LIMITED, Tokyo (JP); Fujitsu Frontech Systems Limited, Maebashi-shi (JP)

(72) Inventor: Mitsuo WATANABE, Inagi-shi (JP)

(73) Assignees: FUJITSU FRONTECH LIMITED, Tokyo (JP); Fujitsu Frontech Systems Limited, Maebashi-shi (JP)

(21) Appl. No.: 19/279,087

(22) Filed: Jul. 24, 2025

Related U.S. Application Data
(63) Continuation of application No. PCT/JP2023/005808, filed on Feb. 17, 2023.

(51) Int. Cl. G07D 11/235; G07D 11/26

(52) U.S. Cl. CPC G07D 11/235; G07D 11/26; G07D 2211/00

(57) ABSTRACT

In a cash processing machine, a first sensor outputs a first detection signal when a front door is opened, a second sensor outputs a second detection signal when an electromagnetic lock is unlocked, and a third sensor outputs a third detection signal when the degree of impact applied to a housing is equal to or greater than a threshold value. A timer starts measuring time from a point of time when reception of the first detection signal is started, and finishes measuring time at a point of time when reception of the second detection signal is finished. A processor outputs an alarm signal, based on a reception state of each detection signal of the first detection signal, the second detection signal, the third detection signal, and measured time of the timer.

### CROSS-REFERENCE TO RELATED APPLICATIONS

This application is a continuation of International Application No. PCT/JP2023/005808, filed on Feb. 17, 2023, the entire contents of which are incorporated herein by reference.

### FIELD

The present disclosure relates to a cash processing machine and an alarm output method.

### BACKGROUND

When a customer purchases an item in a store such as a supermarket, the payment is settled when the customer or a clerk uses a barcode scanner to read the barcode on the item, and registers the item from a point of sale (POS) terminal. Moreover, to settle the payment in cash, a cash processing machine that automatically deposits and dispenses cash may be used.

Because cash is kept in the cash processing machine, to prevent cash from being stolen, an impact detection sensor is provided on the cash processing machine. The cash processing machine issues an alarm when a strong impact applied to the cash processing machine is detected.

An example of related-art is described in Japanese Patent Application Laid-open No. H09-251577.

When a customer carrying items using a cart is to settle the payment, the customer may cause the cart to collide with a cash processing machine. When a strong impact is applied to the cash processing machine by the cart colliding with the cash processing machine, a false alarm is issued even if there is no possibility of cash being stolen from the cash processing machine.

### SUMMARY

A cash processing machine in the present disclosure includes a housing, a front door, an electromagnetic lock that locks the front door, a depositing slot, a dispensing slot, a cash recycling unit, a cash collection cassette, a first sensor, a second sensor, a third sensor, a fourth sensor, a fifth sensor, a timer and a processor. The cash recycling unit is housed in the housing, is capable of sliding back and forth with respect to the housing, identifies and houses cash deposited into the depositing slot, and dispenses cash from the dispensing slot. The cash collection cassette is housed in the cash recycling unit, is capable of sliding back and forth with respect to the cash recycling unit, and stores cash from sales proceeds. The first sensor outputs a first detection signal when the front door is opened. The second sensor outputs a second detection signal when the electromagnetic lock is unlocked. The third sensor outputs a third detection signal when a degree of impact applied to the housing is equal to or greater than a threshold value. The fourth sensor outputs a fourth detection signal when the cash recycling unit is being pulled out from the housing. The fifth sensor outputs a fifth detection signal when the cash collection cassette is being pulled out from the cash recycling unit. The timer starts measuring time from a point of time when reception of the first detection signal is started, and finishes measuring time at a point of time when reception of the second detection signal is finished. The processor outputs an alarm signal, based on a reception state of each detection signal of the first detection signal, the second detection signal, the third detection signal, the fourth detection signal, and the fifth detection signal, and measured time of the timer.

### BRIEF DESCRIPTION OF DRAWINGS

FIG. 1 is a diagram illustrating a configuration example of a cash processing machine of the present disclosure.

FIG. 2 is a diagram illustrating a configuration example of a cash processing machine monitoring system of the present disclosure.

FIG. 3 is a diagram illustrating an example of an alarm determination table of the present disclosure.

### DESCRIPTION OF EMBODIMENTS

Hereinafter, an embodiment of the present disclosure will be described with reference to the accompanying drawings.

In the following embodiment, the same reference numerals denote the same components.

### EMBODIMENT

### <Configuration of Cash Processing Machine>

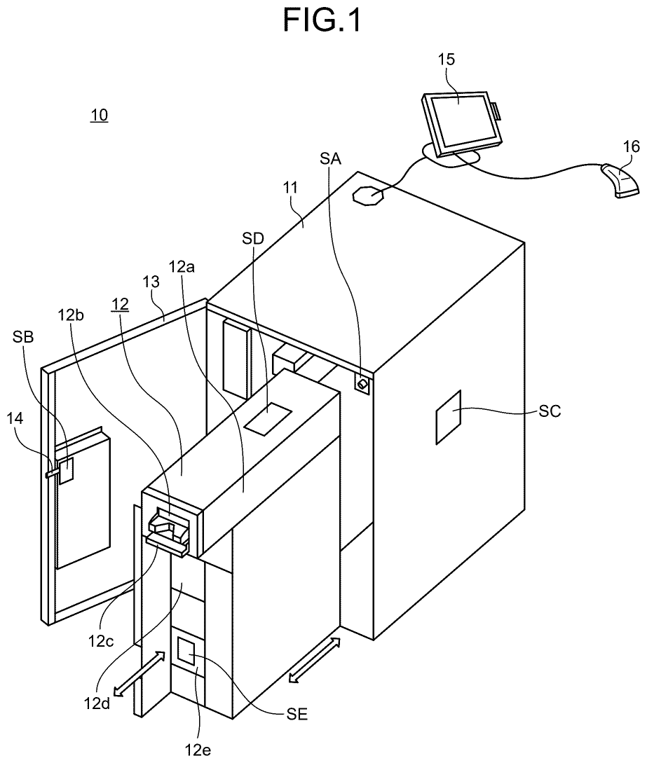

FIG. 1 is a diagram illustrating a configuration example of a cash processing machine of the present disclosure.

In FIG. 1, a cash processing machine 10 includes a housing 11, a bill recycling unit 12, a front door 13, an electromagnetic lock 14, a point of sale (POS) terminal 15, and a code reader 16. The electromagnetic lock 14 is installed on the front door 13. Moreover, the cash processing machine 10 includes a first sensor SA, a second sensor SB, a third sensor SC, a fourth sensor SD, and a fifth sensor SE. The bill recycling unit 12 includes a bill identification unit 12a, a bill depositing slot 12b, a bill dispensing slot 12c, a bill circulating box 12d, and a bill collection cassette 12e. The bill recycling unit 12 identifies and houses the bills deposited into the bill depositing slot 12b, and dispenses bills from the bill dispensing slot 12c.

The front door 13 is openable when the electromagnetic lock 14 is unlocked, and the electromagnetic lock 14 is locked when the front door 13 is closed. The first sensor SA detects the open/close state of the front door 13, and outputs a first detection signal when the front door 13 is opened, and does not output the first detection signal when the front door 13 is closed. For example, the first sensor SA is formed using a push-button type switch. Moreover, the second sensor SB detects the state of the electromagnetic lock 14, and outputs a second detection signal when the electromagnetic lock 14 is unlocked, and does not output the second detection signal when the electromagnetic lock 14 is locked. For example, the second sensor SB is formed using a switch that is turned ON or turned OFF according to the sliding of the electromagnetic lock 14.

The third sensor SC is installed on the side panel of the housing 11, and detects an impact applied to the housing 11. The third sensor SC outputs a third detection signal when the magnitude of impact applied to the housing 11 (hereinafter, may be referred to as a “degree of side impact”) is equal to or greater than a threshold value THA, and does not output the third detection signal when the degree of side impact is less than the threshold value THA. For example, the third sensor SC is formed using an acceleration sensor.

The bill recycling unit 12 is capable of sliding back and forth with respect to the housing 11, is housed in the housing 11 when the bill recycling unit 12 is in operation, and is pulled out from the housing 11 when work is performed on the bill recycling unit 12. The fourth sensor SD is installed on the upper face of the bill recycling unit 12, and detects the insertion/removal state of the bill recycling unit 12 with respect to the housing 11. The fourth sensor SD outputs a fourth detection signal when the bill recycling unit 12 is being pulled out from the housing 11, and does not output the fourth detection signal when the bill recycling unit 12 is housed in the housing 11. For example, the fourth sensor SD is formed using a proximity sensor with respect to the upper face panel of the housing 11, and outputs the fourth detection signal when the distance between the upper face panel and the fourth sensor SD (hereinafter, may be referred to as “distance to the upper face”) is equal to or greater than a threshold value THB, and does not output the fourth detection signal when the distance to the upper face is less than the threshold value THB.

The bill collection cassette 12e is capable of sliding back and forth with respect to the bill recycling unit 12, is housed in the bill recycling unit 12 when the bill recycling unit 12 is in operation, and is pulled out from the bill recycling unit 12 when collecting money. The fifth sensor SE is installed on the bill collection cassette 12e, and detects the insertion/removal state of the bill collection cassette 12e with respect to the bill recycling unit 12. The fifth sensor SE outputs a fifth detection signal when the bill collection cassette 12e is being pulled out from the bill recycling unit 12, and does not output the fifth detection signal when the bill collection cassette 12e is housed in the bill recycling unit 12. For example, the fifth sensor SE is formed using a switch that is turned ON or turned OFF according to the insertion and removal of the bill collection cassette 12e.

The customer registers an item into the POS terminal 15, by reading the code attached to the item using the code reader 16 connected to the POS terminal 15. The POS terminal 15 displays the amount of the registered item on the display of the POS terminal 15.

Every time the code reader 16 reads the code attached to the item, the read code is transmitted to the POS terminal 15. Every time the POS terminal 15 receives the code from the code reader 16, the item is registered in and displayed on the POS terminal 15, and the total amount of the items is updated. Then, the customer settles the payment. The customer deposits cash equal to or greater than the total amount of the items to the cash processing machine 10 from the bill depositing slot 12b, and when the deposited amount is greater than the total amount, the cash processing machine 10 dispenses change from the bill dispensing slot 12c.

The bill identification unit 12a identifies whether the bill deposited from the bill depositing slot 12b is a genuine bill or a counterfeit bill. While the bill identified as a genuine bill is housed in the bill circulating box 12d, the bill identified as a counterfeit bill is dispensed from the bill dispensing slot 12c.

The bill circulating box 12d temporarily houses the bills deposited from the bill depositing slot 12b as the bills to be dispensed, and circulates the bills according to the dispensing amount to the bill dispensing slot 12c.

The bill collection cassette 12e stores bills from the sales proceeds housed in the cash processing machine 10.

### <Configuration of Cash Processing Machine>

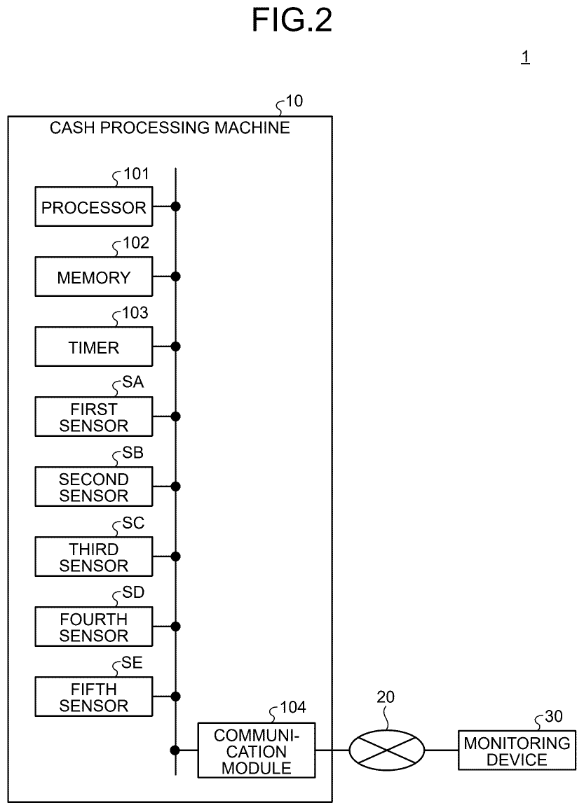

FIG. 2 is a diagram illustrating a configuration example of a cash processing machine monitoring system of the present disclosure.

In FIG. 2, a cash processing machine monitoring system 1 includes the cash processing machine 10, a network 20, and a monitoring device 30. The cash processing machine 10 and the monitoring device 30 are connected via the network 20. The monitoring device 30 monitors the state of the cash processing machine 10 via the network 20.

The cash processing machine 10 includes a processor 101, a memory 102, a timer 103, the first sensor SA, the second sensor SB, the third sensor SC, the fourth sensor SD, the fifth sensor SE, and a communication module 104. The communication module 104 is connected to the network 20.

The first sensor SA continuously outputs the first detection signal to the processor 101 and the timer 103, when the front door 13 is opened. The second sensor SB continuously outputs the second detection signal to the processor 101 and the timer 103, when the electromagnetic lock 14 is unlocked. The third sensor SC continuously outputs the third detection signal to the processor 101, when the degree of side impact is equal to or greater than the threshold value THA. The fourth sensor SD continuously outputs the fourth detection signal to the processor 101, when the bill recycling unit 12 is being pulled out from the housing 11. The fifth sensor SE continuously outputs the fifth detection signal to the processor 101, when the bill collection cassette 12e is being pulled out from the bill recycling unit 12. In the following, the first detection signal, second detection signal, third detection signal, fourth detection signal, and fifth detection signal may be collectively referred to as a “sensor detection signal”.

The timer 103 starts measuring time from the point of time when the electromagnetic lock 14 is unlocked and the front door 13 is opened (hereinafter, may be referred to as a “first point in time”), and finishes measuring time at the point of time when the front door 13 is closed and the electromagnetic lock 14 is locked (hereinafter, may be referred to as a “second point in time”). The timer 103 determines the point of time when the reception of the first detection signal is started as the first point in time, and determines the point of time when the reception of the second detection signal is finished as the second point in time. The processor 101 monitors the measured time of the timer 103, that is, the elapsed time from the first point in time (hereinafter, may be referred to as a “front door open time”).

The processor 101 outputs an alarm signal to the communication module 104, on the basis of the reception state of the sensor detection signal and the front door open time. The communication module 104 transmits the alarm signal received from the processor 101 to the monitoring device 30 via the network 20. Upon receiving an alarm signal from the cash processing machine 10, the monitoring device 30 outputs an alarm. For example, upon receiving an alarm signal from the cash processing machine 10, the monitoring device 30 displays an alarm screen on the display of the monitoring device 30. Moreover, for example, upon receiving an alarm signal from the cash processing machine 10, the monitoring device 30 outputs an alarm sound from a speaker of the monitoring device 30.

### <Operation of Cash Processing Machine>

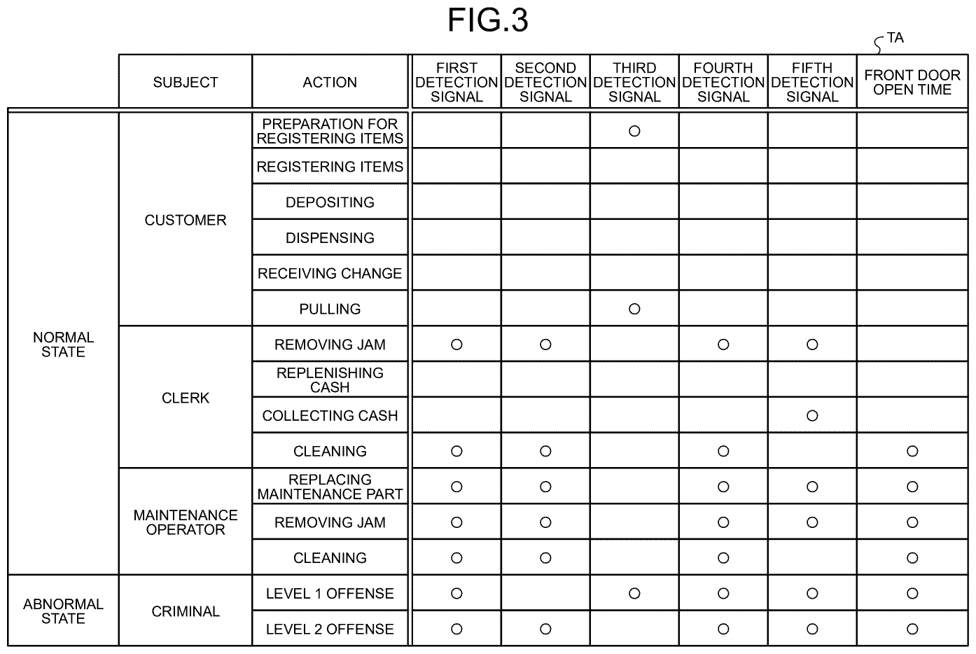

FIG. 3 is a diagram illustrating an example of an alarm determination table of the present disclosure. An alarm determination table TA illustrated in FIG. 3 is stored in advance in the memory 102.

As illustrated in FIG. 3, in the alarm determination table TA, the states of the cash processing machine 10, actions performed on the cash processing machine 10, subjects of the actions, the output state of the sensor detection signals, and the state of the front door open time are associated and set in advance. In the columns of the sensor detection signals in the alarm determination table TA, a circle indicates that a sensor detection signal is output, and a blank indicates that the sensor detection signal is not output. Moreover, in the column of the front door open time in the alarm determination table TA, a circle indicates that the front door open time is equal to or greater than a threshold value THC, and a blank indicates that the front door open time is less than the threshold value THC.

By referring to the alarm determination table TA on the basis of the reception state of the sensor detection signal and the front door open time, the processor 101 determines whether the cash processing machine 10 is in a normal state or in an abnormal state. Then, while outputting an alarm signal to the communication module 104 when it is determined that the cash processing machine 10 is in an abnormal state, the processor 101 does not output the alarm signal to the communication module 104 when it is determined that the cash processing machine 10 is in a normal state.

Thus, for example, when the first detection signal, third detection signal, fourth detection signal, and fifth detection signal among the first to fifth detection signals are received while the second detection signal is not received, and when the front door open time is equal to or greater than the threshold value THC, the processor 101 determines that the cash processing machine 10 is in an abnormal state where a Level 1 offense is committed to the cash processing machine 10 by a criminal, and outputs an alarm signal. An example of the Level 1 offense includes stealing cash by breaking the front door 13 open.

Moreover, for example, when the first detection signal, second detection signal, fourth detection signal, and fifth detection signal among the first to fifth detection signals are received while the third detection signal is not received, and when the front door open time is equal to or greater than the threshold value THC, the processor 101 determines that the cash processing machine 10 is in an abnormal state where a Level 2 offense is committed to the cash processing machine 10 by a criminal, and outputs an alarm signal. An example of the Level 2 offense includes an action of stealing where a clerk, a maintenance operator, a cash collector, or the like takes out cash from the bill collection cassette 12e.

On the other hand, for example, when the third detection signal among the first to fifth detection signals is received and the front door open time is less than the threshold value THC, the processor 101 determines that a normal action such as preparation for registering items or pulling a cart from the cash processing machine 10 is being performed on the cash processing machine 10 by the customer, and does not output an alarm signal.

Moreover, for example, when the first detection signal, second detection signal, fourth detection signal, and fifth detection signal among the first to fifth detection signals are received, and when the front door open time is less than the threshold value THC, the processor 101 determines that a normal action of removing the jammed bill is being performed on the cash processing machine 10 by a clerk, and does not output an alarm signal.

Furthermore, for example, when the fifth detection signal among the first to fifth detection signals is received, and when the front door open time is less than the threshold value THC, the processor 101 determines that a normal action of collecting cash is being performed on the cash processing machine 10 by a clerk, and does not output an alarm signal.

Still furthermore, for example, even if the front door open time is equal to or greater than the threshold value THC, when the first detection signal, second detection signal, and fourth detection signal among the first to fifth detection signals are received while the third detection signal and fifth detection signal are not received, the processor 101 determines that a normal action of cleaning is being performed on the cash processing machine 10 by a clerk, and does not output an alarm signal.

Still furthermore, for example, even if the front door open time is equal to or greater than the threshold value THC, when the first detection signal, second detection signal, fourth detection signal, and fifth detection signal among the first to fifth detection signals are received while the third detection signal is not received, the processor 101 determines that a normal action of replacing a maintenance part or removing the jammed bill is being performed on the cash processing machine 10 by a maintenance operator, and does not output an alarm signal.

Still furthermore, for example, even if the front door open time is equal to or greater than the threshold value THC, when the first detection signal, second detection signal, and fourth detection signal among the first to fifth detection signals are received while the third detection signal and fifth detection signal are not received, the processor 101 determines that a normal action of cleaning is being performed on the cash processing machine 10 by a maintenance operator, and does not output an alarm signal.

The embodiment has been described above.

Note that, in the above description, an example of cash is bills. However, the disclosed technique is also applicable to a cash processing machine that handles coins as cash. That is, the disclosed technique is also applicable to a cash processing machine installed with a coin recycling unit that has the same function as that of the bill recycling unit 12 on coins. The bill recycling unit and the coin recycling unit may be collectively referred to as a “cash recycling unit”.

As described above, the cash processing machine in the present disclosure (cash processing machine 10 in the embodiment) includes a housing (housing 11 in the embodiment), a front door (front door 13 in the embodiment), an electromagnetic lock that locks the front door (electromagnetic lock 14 in the embodiment), a depositing slot (bill depositing slot 12b in the embodiment), a dispensing slot (bill dispensing slot 12c in the embodiment), a cash recycling unit (bill recycling unit 12 in the embodiment), a cash collection cassette (bill collection cassette 12e in the embodiment), a first sensor (first sensor SA in the embodiment), a second sensor (second sensor SB in the embodiment), a third sensor (third sensor SC in the embodiment), a fourth sensor (fourth sensor SD in the embodiment), a fifth sensor (fifth sensor SE in the embodiment), a timer (timer 103 in the embodiment), and a processor (processor 101 in the embodiment). The cash recycling unit is housed in the housing, is capable of sliding back and forth with respect to the housing, identifies and houses the cash deposited into the depositing slot, and dispenses cash from the dispensing slot. The cash collection cassette is housed in the cash recycling unit, is capable of sliding back and forth with respect to the cash recycling unit, and stores cash from the sales proceeds. The first sensor outputs a first detection signal when the front door is opened. The second sensor outputs a second detection signal when the electromagnetic lock is unlocked. The third sensor outputs a third detection signal when the degree of impact applied to the housing is equal to or greater than a threshold value. The fourth sensor outputs a fourth detection signal when the cash recycling unit is being pulled out from the housing. The fifth sensor outputs a fifth detection signal when the cash collection cassette is being pulled out from the cash recycling unit. The timer starts measuring time from the point of time when the reception of the first detection signal is started, and finishes measuring time at the point of time when the reception of the second detection signal is finished. The processor outputs an alarm signal, on the basis of the reception state of each detection signal of the first detection signal, the second detection signal, the third detection signal, the fourth detection signal, and the fifth detection signal, and the measured time of the timer.

For example, the processor outputs an alarm signal, when the first detection signal, third detection signal, fourth detection signal, and fifth detection signal are received while the second detection signal is not received, and when the measured time is equal to or greater than a threshold value.

Moreover, for example, the processor outputs an alarm signal, when the first detection signal, second detection signal, fourth detection signal, and fifth detection signal are received while the third detection signal is not received, and when the measured time is equal to or greater than a threshold value.

In this manner, by outputting an alarm signal on the basis of the reception state of each detection signal of the first detection signal, the second detection signal, the third detection signal, the fourth detection signal, and the fifth detection signal, and the measured time of the timer, it is possible to prevent a cash processing machine from issuing a false alarm.

According to the disclosed technique, it is possible to prevent a cash processing machine from issuing a false alarm.

Although the present disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A cash processing machine, comprising:
a housing;
a front door:
an electromagnetic lock that locks the front door;
a depositing slot;
a dispensing slot;
a cash recycling unit that is housed in the housing, that is capable of sliding back and forth with respect to the housing, that identifies and houses cash deposited into the depositing slot, and that dispenses cash from the dispensing slot;
a cash collection cassette that is housed in the cash recycling unit, that is capable of sliding back and forth with respect to the cash recycling unit, and that stores cash from sales proceeds;
a first sensor that outputs a first detection signal when the front door is opened;
a second sensor that outputs a second detection signal when the electromagnetic lock is unlocked;
a third sensor that outputs a third detection signal when a degree of impact applied to the housing is equal to or greater than a threshold value;
a fourth sensor that outputs a fourth detection signal when the cash recycling unit is being pulled out from the housing;
a fifth sensor that outputs a fifth detection signal when the cash collection cassette is being pulled out from the cash recycling unit;
a timer that starts measuring time from a point of time when reception of the first detection signal is started, and finishes measuring time at a point of time when reception of the second detection signal is finished; and
a processor that outputs an alarm signal, based on a reception state of each detection signal of the first detection signal, the second detection signal, the third detection signal, the fourth detection signal, and the fifth detection signal, and measured time of the timer.

2. The cash processing machine according to claim 1, wherein the processor outputs the alarm signal, when the first detection signal, the third detection signal, the fourth detection signal, and the fifth detection signal are received while the second detection signal is not received, and when the measured time is equal to or greater than a threshold value.

3. The cash processing machine according to claim 1, wherein the processor outputs the alarm signal, when the first detection signal, the second detection signal, the fourth detection signal, and the fifth detection signal are received while the third detection signal is not received, and when the measured time is equal to or greater than a threshold value.

4. An alarm output method in a cash processing machine that includes:
a housing;
a front door;
an electromagnetic lock that locks the front door;
a depositing slot;
a dispensing slot;
a cash recycling unit that is housed in the housing, that is capable of sliding back and forth with respect to the housing, that identifies and houses cash deposited into the depositing slot, and that dispenses cash from the dispensing slot;
a cash collection cassette that is housed in the cash recycling unit, that is capable of sliding back and forth with respect to the cash recycling unit, and that stores cash from sales proceeds;
a first sensor that outputs a first detection signal when the front door is opened;
a second sensor that outputs a second detection signal when the electromagnetic lock is unlocked;
a third sensor that outputs a third detection signal when a degree of impact applied to the housing is equal to or greater than a threshold value;
a fourth sensor that outputs a fourth detection signal when the cash recycling unit is being pulled out from the housing; and
a fifth sensor that outputs a fifth detection signal when the cash collection cassette is being pulled out from the cash recycling unit; the alarm output method, comprising:
by using a timer, starting measuring time from a point of time when reception of the first detection signal is started, and finishing measuring time at a point of time when reception of the second detection signal is finished; and
by using a processor, outputting an alarm signal, based on a reception state of each detection signal of the first detection signal, the second detection signal, the third detection signal, the fourth detection signal, and the fifth detection signal, and measured time of the timer.
